(19) United States
(12) Patent Application Publication
(10) Pub. No.: US 2025/0306976 A1
(43) Pub. Date: Oct. 2, 2025

(54) RESOURCE OPTIMIZATION DEVICE, RESOURCE OPTIMAZATION METHOD, AND STORAGE MEDIUM

(71) Applicant: NEC Platforms Ltd., Kawasaki-shi (JP)

(72) Inventors: Ken TONARI, Kanagawa (JP); Ryo SUZUKI, Kanagawa (JP); Takumi OKAMURA, Kanagawa (JP)

(73) Assignee: NEC Platforms Ltd., Kawasaki-shi (JP)

(21) Appl. No.: 19/063,529

(22) Filed: Feb. 26, 2025

(30) Foreign Application Priority Data
Mar. 27, 2024 (JP) 2024-050872

(51) Int. Cl. G06F 9/455

(52) U.S. Cl. CPC G06F 9/45558; G06F 2009/45583

(57) ABSTRACT

A resource optimization device applies a time-series prediction algorithm to historical resource data for each of a plurality of host VMs to predict future predicted resource data for each of the plurality of host VMs; determines a high-load host VM among the plurality of VMs based on the historical resource data and the future resource data of each of the plurality of VMs; and determines a migration destination host VM to which a migration target guest VM of at least one of the high-load host VMs is to be moved.

### CROSS-REFERENCE TO RELATED APPLICATIONS

This application is based upon and claims the benefit of priority from Japanese patent application No. 2024-050872, filed on Mar. 27, 2024, the disclosure of which is incorporated herein in its entirety by reference.

### TECHNICAL FIELD

The present disclosure relates to a resource optimization device, a resource optimization method, and a storage medium.

### BACKGROUND ART

In the operation of virtual machines (VMs), there is a technique for optimizing resources of the entire VM by proposing migration of a guest VM from a high-load host VM to a low-load host VM. Since human optimization relies on experience and is time consuming, it has been proposed to perform migration based on predictions of the VM's future load.

For example, Japanese Unexamined Patent Application Publication No. 2012-181647 proposes predicting a load based on actual measurements during the same time period, and then comparing the predicted value with the actual measurement value to correct the prediction.

However, the above technique has a problem in that it is not possible to relocate guest VMs while taking into account the load conditions from the past to the future.

An example object of the present disclosure is to provide a resource optimization device, a resource optimization method, and a computer program that solve the above-mentioned problems.

### SUMMARY

A resource optimization device according to one example aspect of the present disclosure is provided with: a resource data prediction portion configured to apply a time-series prediction algorithm to historical resource data for each of a plurality of host virtual machines to predict future predicted resource data for each of the plurality of host virtual machines, wherein the historical resource data and the future predicted resource data are time-series data; a high-load virtual machine determination portion configured to determine a high-load host virtual machine among the plurality of host virtual machines based on the historical resource data and the future resource data of each of the plurality of host virtual machines; and a migration target determination portion configured to determine a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

A resource optimization method according to one example aspect of the present disclosure includes: a step that applies a time-series prediction algorithm to historical resource data for each of a plurality of host virtual machines to predict future predicted resource data for each of the plurality of host virtual machines, wherein the historical resource data and the future predicted resource data are time-series data; a step that determines a high-load host virtual machine among the plurality of host virtual machines based on the historical resource data and the future resource data of each of the plurality of host virtual machines; and a step that determines a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

A non-transitory storage medium storing a computer program according to one example aspect of the present disclosure causes a processor to function as: a resource data prediction means configured to apply a time-series prediction algorithm to historical resource data for each of a plurality of host virtual machines to predict future predicted resource data for each of the plurality of host virtual machines, wherein the historical resource data and the future predicted resource data are time series data; a high-load virtual machine determination means configured to determine a high-load host virtual machine among the plurality of host virtual machines based on the historical resource data and the future resource data of each of the plurality of host virtual machines; and a migration target determination means configured to determine a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

### BRIEF DESCRIPTION OF THE DRAWINGS

FIG. 1 is a diagram showing a configuration of a resource optimization device 1 according to the present disclosure.

FIG. 2 is a diagram showing exemplary time-stamped resource data.

FIG. 3 is a diagram showing an exemplary baseline change detection and learning period.

FIG. 4 is a diagram showing the relationship between exemplary optimization learning data and peak detection after Fourier transform.

FIG. 5 is a diagram illustrating an exemplary high load determination.

FIG. 6 is a diagram illustrating an exemplary high load determination.

FIG. 7 is a diagram showing an example resource trend classification.

FIG. 8 is a process flow diagram of the resource optimization device 1 according to the present disclosure.

FIG. 9 is a diagram showing a configuration of a capacity planning system 2 according to the present disclosure.

FIG. 10 is a flow diagram of a process for detecting a high-load VM performed by the capacity planning system 2 according to the present disclosure.

FIG. 11 is a process flow diagram of a future prediction operation of a VM load status performed by the capacity planning system 2 according to the present disclosure.

FIG. 12 is a process flow diagram of a prediction operation of the number of mountable VMs performed by the capacity planning system 2 according to the present disclosure.

FIG. 13 is a process flow diagram of a first mounting number prediction in a case where overcommitment according to the present disclosure is not taken into consideration.

FIG. 14 is a diagram showing an exemplary relationship between allocated, reserved, and remaining vCPUs for a host VM.

FIG. 15 is a diagram showing an exemplary relationship between the amount of installed memory, the amount of allocated memory, and the amount of reserved memory in a host VM.

FIG. 16 is a process flow diagram of a second mounting number prediction executed in a case where overcommit is taken into consideration according to the present disclosure.

FIG. 17 is a diagram showing a graph of time series data obtained by adding the memory usage of a guest VM to the memory usage of a host VM.

FIG. 18 is a process flow diagram of a VM migration destination proposal operation performed by the capacity planning system 2 according to the present disclosure.

FIG. 19 is a process flow diagram of a first migration destination proposal procedure executed in a case where overcommit is not taken into consideration in accordance with the present disclosure.

FIG. 20 is a process flow diagram of a second migration destination proposal procedure executed in a case where overcommit is taken into consideration in accordance with the present disclosure.

FIG. 21 is a diagram showing the resource optimization device 3 according to the present disclosure.

FIG. 22 is a diagram showing a process of the resource optimization device 3 according to the present disclosure.

FIG. 23 is a diagram showing a hardware configuration of the resource optimization device 4 according to the present disclosure.

### EXAMPLE EMBODIMENT

### First Example Embodiment

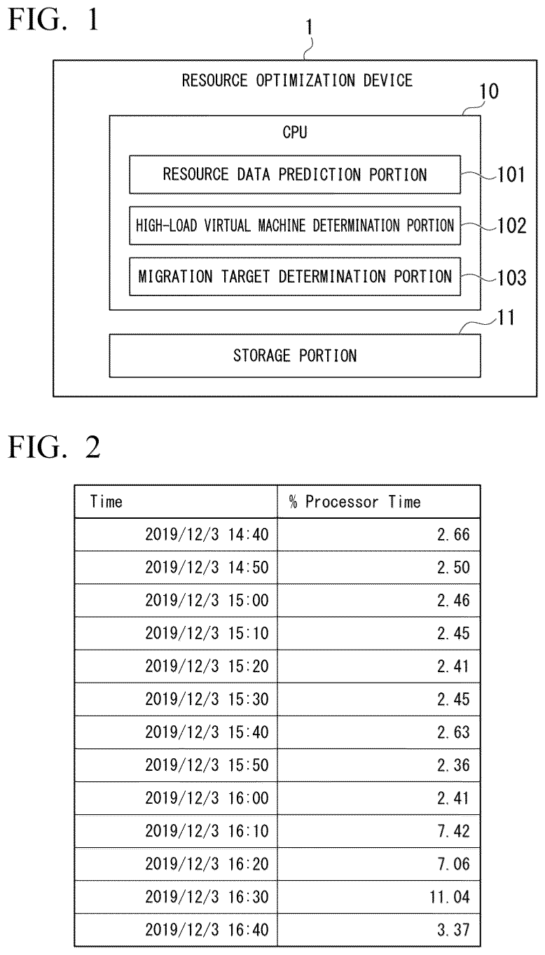

Hereinbelow, a resource optimization device 1 according to the first example embodiment will be described with reference to FIGS. 1 to 7.

### (Functional Configuration of Resource Optimization Device 1)

FIG. 1 is a diagram showing a configuration of the resource optimization device 1 according to the present disclosure. The resource optimization device 1 is a device configured to optimize resources among a plurality of host VMs.

The resource optimization device 1 is provided with a Central Processing Unit (CPU) 10 and a storage portion 11. The CPU 10 is a processor that controls the entire resource optimization device 1, and operates according to a computer program (hereinafter, simply referred to as a program) recorded in the storage portion 11, for example. Therefore, the program may cause the CPU 10 to function as each functional portion of the resource optimization device 1. The storage portion 11 may be a computer-readable recording medium for recording predetermined information. For ease of explanation, the resource optimization device 1 according to the first example embodiment has a storage portion 11 built therein; however, in other example embodiments, the storage portion 11 is implemented as an external storage device of the resource optimization device 1, and the resource optimization device 1 can also acquire information from the external storage device.

The CPU 10 operates according to the program to function as a resource data prediction portion 101, a high-load virtual machine determination portion 102, and a migration target determination portion 103. The functional configuration will be described below.

The resource data prediction portion 101 is configured to predict future predicted resource data for a VM based on historical resource data for the VM. Resource data (including historical resource data and future predicted resource data) as used herein refers to time series data of resource information of a VM over a given period of time. The resource data includes CPU usage, memory usage, disk usage, and network usage. Moreover, the resource data is time-stamped resource data. For example, the resource data may be a time-stamped processor time as shown in FIG. 2. Moreover, historical resource data means past resource data. Since resource data can be defined for both a host VM and a guest VM, the VM that is the target of resource prediction may be either a host VM or a guest VM.

The resource data prediction portion 101 can apply a time-series prediction algorithm for time-series data (autoregression, moving average, autoregressive moving average, seasonal autoregressive integrated moving average, vector autoregression, state space, neural networks such as LSTM, and ensemble methods of various algorithms, etc.) to historical resource data, thereby predicting future resource data.

Some time-series prediction algorithms set periodicity parameters of time-series data as inputs in a case where predicting future data of time-series data. The periodic component parameter indicates how many pieces of resource data constitute one period. In a case where using such a time-series prediction algorithm, the resource data prediction portion 101 may optimize the periodic component parameter. The procedure for optimizing the periodic component parameters is carried out as in the following (1) to (5).

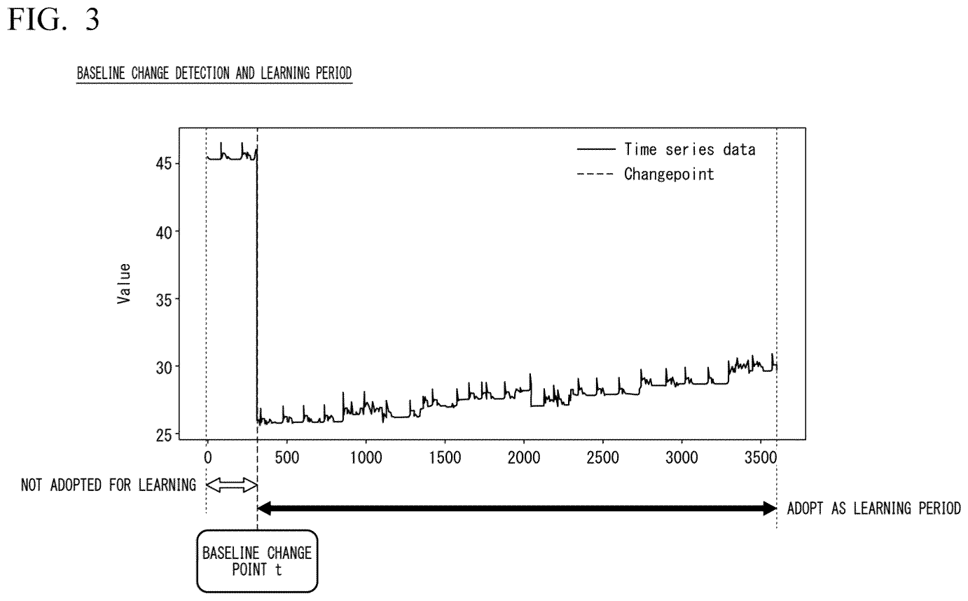

(1) For all data in the historical resource data, verify whether any baseline fluctuations have occurred during the period. If a baseline fluctuation has occurred, only the most recent baseline data is extracted. This makes it possible to avoid a decrease in prediction accuracy due to baseline fluctuations. In the example shown in FIG. 3, a baseline change occurs at baseline change time t, so historical resource data after baseline change time t is extracted.

(2) Next, the historical resource data extracted in (1) is divided into learning data and validation data. Hereinafter, this learning data will be referred to as “optimization learning data” in the sense of being learning data used in the optimization procedure. The model in the time-series prediction algorithm is learned by adjusting the parameters of the model so as to fit the optimization learning data. In the above division, the older data in chronological order may be used as the optimization learning data, and the newer data may be used as the validation data. For example, if there is data for five months from January to May, the three months from January to March can be used as the optimization learning data, and the two months from April to May can be used as the validation data. However, the ratio and period are not limited to these.

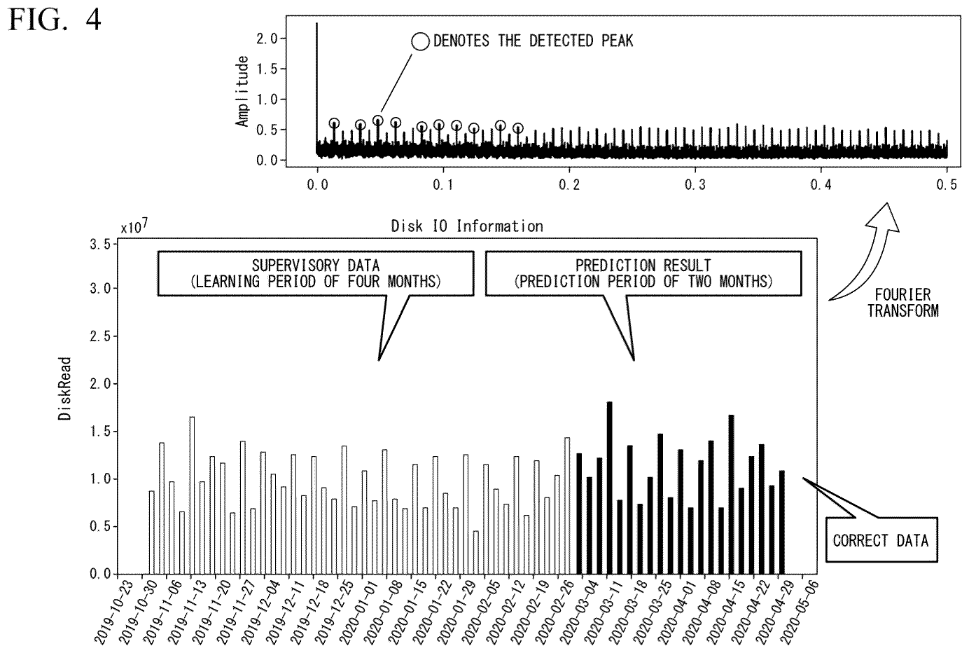

(3) Next, a Fourier transform is performed on the optimization learning data, and peak detection is performed on the result of the Fourier transform. In the example shown in FIG. 4, similarly to the above example, four months' worth of historical resource data is used as optimization learning data. As is known, the Fourier transform can calculate the frequency components of the time-series data of a target. As shown in FIG. 4, the result of the Fourier transform often has multiple peaks, so some of the main peaks may be adopted.

(4) The period of the detected peak is set as a periodic component parameter, and a time-series prediction algorithm is applied to the optimization learning data to perform a prediction for the same period as the validation data. This operation is performed for at least some of the multiple detected peaks (for example, the main peaks having large peak values).

(5) Next, the Mean Absolute Error (MAE) of the prediction results for each peak and the validation data is calculated and compared. The most accurate peak value is determined as the periodicity parameter. The above is the procedure for optimizing the periodic component parameters.

The resource data prediction portion 101 can use the periodic component parameters determined as described above to apply a time-series prediction algorithm to all of the historical resource data, thereby making a time-series prediction. By optimizing the periodic component parameters in this way, it is possible to perform tuning faster than by methods such as grid search optimization and Bayesian optimization.

Next, the high-load virtual machine determination portion 102 is configured to determine a high-load VM based on the historical resource data and future predicted resource data of each of the VMs. The VM may be a host VM or a guest VM. If the VM is a host VM, the host VM determined to be a high-load VM can be a candidate for the migration source of the guest VM. Furthermore, if the VM is a guest VM, the high load determination of the guest VM is taken into consideration in a case where determining the guest to be migrated. More specifically, the high-load virtual machine determination portion 102 determines that a VM is high-loaded in a case where the following two-stage determination conditions are satisfied.

### High-Load VM First Determination

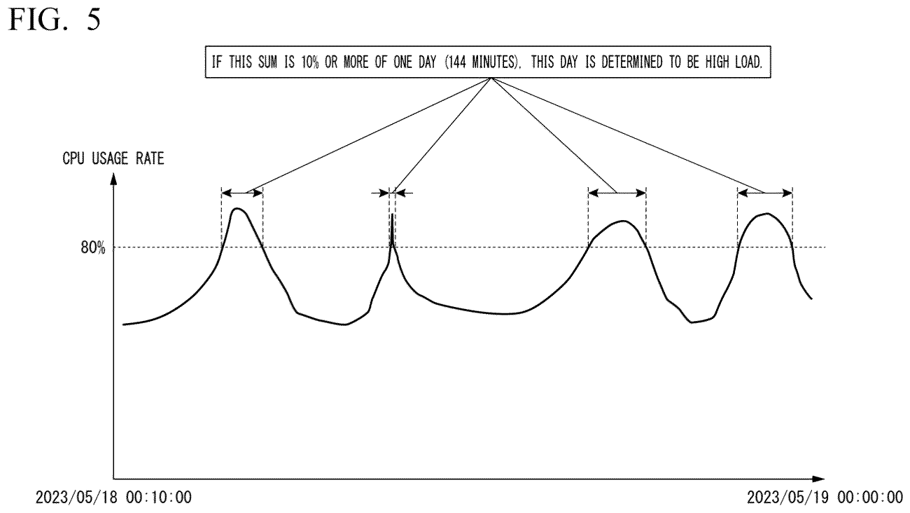

If the resource data exceeds the threshold value during a predetermined percentage of a time period having a first length (hereinafter referred to as a first period, for example, one day), the period is considered high load. This threshold value is also referred to as a “critical level” in this specification, and if the resource data is a CPU utilization rate, for example, the CPU utilization rate may be 80%. The critical level can be changed to any value by a user who is a system engineer or a system administrator. For example, as shown in FIG. 5, if the first length is set to one day, the above-mentioned “predetermined percentage time period” is set to 10% of one day (144 minutes), and the critical level is set to a CPU usage rate of 80%, then if the CPU usage rate is 80% for a period of 144 minutes or more in one day, then that day is determined to be high load. In this example embodiment, the critical level is described as an example, but a plurality of thresholds such as a warning level and a surplus allocation level may be set. The surplus allocation level is set to a low value such as 20% or 40% in order to detect whether more resources than necessary are being allocated to a VM, and if the high load detection threshold is not met, it is determined that there is surplus allocation. In addition, in the present example embodiment, an example is described in which a period having a first length is determined to be high load in a case where a “predetermined percentage of the time period” exceeds a threshold value, but the determination may also be made based on a percentile and a threshold value in the period having the first length.

### High-Load VM Second Determination

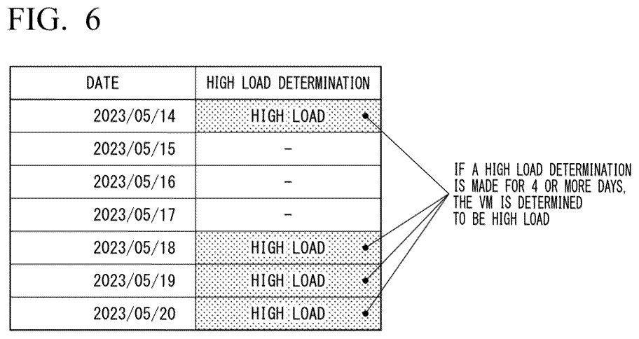

A period with a second length longer than the first length (hereinafter referred to as the second period, for example, one week) is checked to see how many times the first period, judged as high load, occurs within it. In the case of the first period determined to be high load being a predetermined number of times or more, the corresponding VM is determined to be high load. Note that if the high-load first periods occur consecutively, the count may include these as a single instance, or they may be counted individually as non-consecutive occurrences. For example, as shown in FIG. 6, if there are four or more instances (i.e., four or more days) within the second period of one week where the first period is determined to be high load, the VM may be determined to be high load. In the following, such a determination of a high-load VM is also referred to as “high-load VM detection.”

As described above, the resource data prediction portion 101 can generate future predicted resource data of a VM. In response to this, the high-load virtual machine determination portion 102 can determine whether the VM is high load based on the VM's historical resource data and the future predicted resource data of the VM predicted by the resource data prediction portion 101. This makes it possible to determine whether or not the VM is high load based on both past resource data and predicted resource data, and also to predict in a case where (for example, in which week) the high load may occur.

The migration target determination portion 103 is configured to determine a migration destination host VM to which a guest VM in at least one of the host VMs determined by the high-load virtual machine determination portion 102 to be high load is to be migrated. The migration destination host VM may be a host VM that is determined not to be a high-load VM. The migration target determination portion 103 can determine each of a migration source host VM, a migration target guest VM in the migration source host VM, and a migration destination host VM.

### Determination of Migration Source Host

First, the determination of the migration source host VM will be described. Based on the result of the high-load VM detection, high-load host VMs and non-high-load host VMs are listed, and the migration target determination portion 103 selects one of the high-load host VMs as the migration source host VM. At this time, the host with a higher degree of load may be preferentially adopted as the migration source host VM.

### Determination of Migration Target Guest

The migration target determination portion 103 then selects a migration target guest VM in the selected migration source host based on a predetermined condition. The predetermined condition may include a condition based on a resource trend classification regarding the load status of the guest VM. The resource trend classifications are described below.

The migration target determination portion 103 may decompose at least one of the historical resource data and the future predicted resource data into (i) a trend component, (ii) a seasonal component, and (iii) a residual. The trend component is a component of long-term data fluctuation, the seasonal component is a component of periodic data fluctuation, and the residual is a data fluctuation component that includes error fluctuation and suddenly occurring specific changes. The decomposition method may be, but is not limited to, Seasonal Decomposition of Time Series by Loess (STL decomposition). After decomposition into each component, the trend is classified for each extracted component.

The trend component may be classified as an upward trend, a downward trend, or a constant trend. For example, linear regression is performed on the extracted trend component to obtain the slope. If the slope is above a certain level (e.g., 0.2), it is an increasing trend; if it is below a certain level (e.g., −0.2), it is a decreasing trend; otherwise (e.g., greater than −0.2 and less than 0.2), it is a constant trend.

Additionally, seasonal components may be classified as “seasonal” or “non-seasonal.” For example, the maximum absolute value of the extracted seasonal components is obtained, and if this is equal to or greater than a certain value, it is determined that there is seasonality.

Residuals may also be classified as rising sharply, falling sharply, fluctuating, or not fluctuating. For example, linear regression is performed on resource data for a certain period (for example, seven days) to obtain a slope. Next, a slope is similarly obtained for the resource data for the same fixed period following that period (the next seven days from one day after the first seven days). This operation is repeated for the target period to obtain the slope for all fixed periods. Check whether each slope is above the upper limit or below the lower limit. If there is no fluctuation, it is determined that there is no fluctuation. If any value is above the upper limit, it is determined that there is a sudden rise; if any value is below the lower limit, it is determined that there is a sudden fall; and if both trends are present, it is determined that there is a volatile fluctuation.

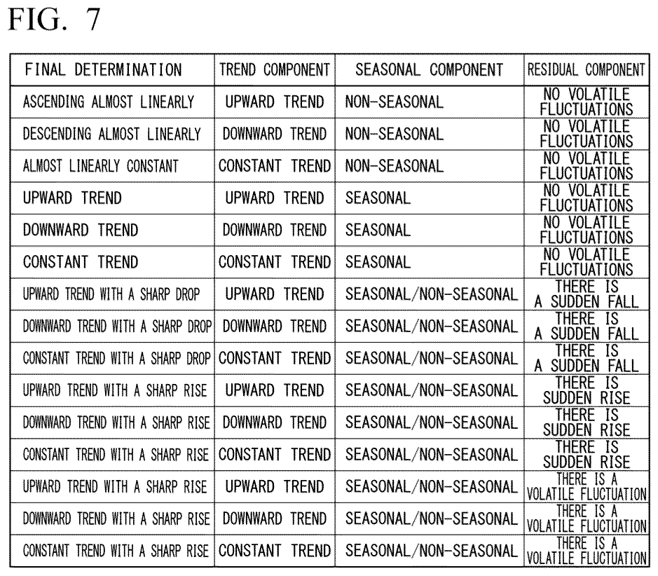

The final classification is the combination of the classifications for each component. In the above example, as shown in FIG. 7, the items can be classified into 15 types. This concludes the explanation of resource trend classification.

The migration target determination portion 103 can select a migration target guest VM from among the guest VMs in the selected migration source host based on the above trend classification. For example, the migration target determination portion 103 may select, as a first priority, a migration target whose impact on the migration destination host VM is easy to predict, based on the trend classification. For example, the migration target determination portion 103 may select, as the first priority, a VM whose trend component has a constant trend. Furthermore, the selection of a guest VM may be based on whether the periodic change of the seasonal component is constant, whether the classification of the residual component is judged to be free of wild fluctuations, or the like. This makes the impact on the resource state of the migration destination constant or easy to predict, improving the accuracy of prediction of the resource status of the migration destination host VM after migration. If there are multiple guest VMs (e.g., guest VMs with a certain trend) that are selected as candidates for migration, then the high-load guest VM that is determined to be high-load in high-load VM detection targeting guest VMs may be given second priority. As described above, the high-load virtual machine determination portion 102 can execute high-load VM detection targeting guest VMs. If this still does not determine the order, the order can be the order of highest average resource utilization.

### Determination of Migration Destination Host

Next, the migration target determination portion 103 selects a migration destination host VM from among the host VMs determined not to be high load, based on the resource state of the host VM. For example, the migration destination host VM may preferentially select a candidate that uses less resources. More specifically, the following three-stage determination may be performed to determine whether or not a candidate host VM is actually selected. In any case, if determined to be suitable as the migration destination host VM in any of the determinations, the candidate host VM is selected as the migration destination host VM.

### (1) Primary Determination of Migration Destination Candidate Host

First, it is determined whether the migration target guest VM can be migrated from the viewpoint of the amount of free resources in the migration destination candidate host VM. The amount of allocated resources of the migration target guest VM (e.g., the number of allocated vCPUs and the allocated physical memory size) is compared with the amount of free resources of the migration destination candidate host VM (e.g., the allocatable vCPUs and allocatable physical memory) to check whether migration is possible. Specifically, it is determined that movement is possible in a case where the following two expressions are simultaneously satisfied.

vCPU allocation for the migration target guest<=vCPU available of migration destination candidate host

Physical memory allocation size of the migration target guest<=allocatable physical memory of migration destination candidate host

### (2) Secondary Determination of Migration Destination Candidate Host

Next, the resource state of the migration destination candidate host VM is judged as to whether or not the resources of the host VM will be depleted due to the migration of the migration target guest VM. If it is determined that there will be no exhaustion, the candidate host VM is determined in the second determination to be suitable as a migration destination. Furthermore, the determination of whether or not the resources of the host VM will be depleted may be performed using different procedures depending on whether or not overcommit is taken into consideration. First, in a case where overcommit is not taken into consideration, resources are judged based only on the allocatable amount, similarly to the above-mentioned primary determination. In other words, in a case where overcommit is not taken into consideration, it is possible to make a determination based on the same criteria as the primary determination, and therefore the secondary determination can be omitted.

Next, in a case where overcommit is taken into consideration, high-load VM detection is performed on the time-series resource data of the host VM after migration to check whether a high-load determination occurs, thereby determining whether resources will be depleted. In the following, a procedure for calculating the memory usage rate of the host after migration, which corresponds to the resource data of the host VM after migration, in a case where the memory usage rate is used as the resource data, will be described.

The memory usage rate of the host after migration may be defined as

(Memory usage of host after migration)/(Amount of memory installed on host)

First, the amount of available physical memory of the host VM and the amount of available physical memory of the host VM after migration are calculated using the following equation.

(Amount of available physical memory of host)=(Amount of memory installed on the host)−(Amount of memory installed on the host×Estimated memory usage rate)

(Amount of physical memory in use by guest)=(Amount of memory allocated to VM−“Available MBytes” of VM)

Next, the amount of available physical memory of the host after the migration is calculated as follows.

(Amount of available physical memory on host after migration)=(Amount of available physical memory on host)−(Amount of physical memory in use by guest)

Then, the memory usage of the host after the migration is calculated as follows:

(Memory usage of host after migration)=(Amount of memory installed on host)−(Amount of available physical memory of host after migration)

According to the above definition, the memory usage rate of the host after the migration is obtained by dividing the memory usage of the host after the migration by the amount of memory installed in the host.

If a high-load VM is not determined to be high-load in the high-load VM detection performed on the memory usage rate of the host VM after migration, the host VM that is a candidate for the migration destination is determined to have resources that will not be depleted by the migration (i.e., is suitable as a migration destination).

### (3) Tertiary Determination of Migration Destination Candidate Host

For a host VM that is determined to be a suitable migration destination in the aforementioned primary and secondary determinations, it may be further determined whether or not the resource status of the migration source host will be improved by migrating the migration target guest VM. If improvement is required, the migration destination candidate host VM is selected as the migration destination host VM. If no improvement is made, the above-mentioned determination is made for the migration destination candidate host VM with the next highest priority.

### (Process Flow of Resource Optimization Device 1)

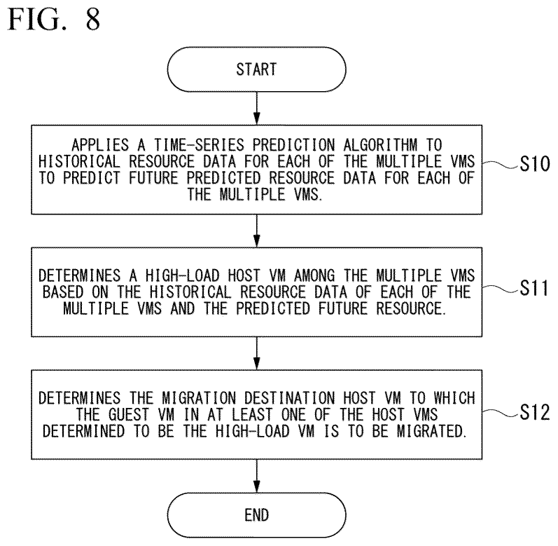

FIG. 8 is the process flow of the resource optimization device 1 according to the present disclosure. The process flow of the resource optimizing device 1 is started in a case where the CPU 10 of the resource optimizing device 1 executes a computer program stored in the storage portion 11, for example.

First, in Step S10, the resource data prediction portion 101 of the resource optimization device 1 applies a time-series prediction algorithm to historical resource data for each of the multiple VMs to predict future predicted resource data for each of the multiple VMs. As previously explained, the historical resource data and future predicted resource data are time-series data. The multiple VMs include at least one of a host VM and a guest VM.

Next, in Step S11, the high-load virtual machine determination portion 102 of the resource optimizing device 1 determines a high-load host VM among the multiple VMs based on the historical resource data of each of the multiple VMs and the predicted future resource data. A specific method for detecting a high-load VM may be, for example, the method described above with respect to the resource data prediction portion 101. The criteria for determining the high-load host VM may be different for the guest VM and the host VM.

Next, in Step S12, the migration target determination portion 103 of the resource optimization device 1 determines the migration destination host VM to which the guest VM in at least one of the host VMs determined to be the high-load VM is to be migrated. The migration destination host VM may be a host VM that is not a high-load VM in Step S11, among the multiple host VMs. More specifically, Step S12 includes a step of selecting a migration source host VM from the host VMs determined to be high-load VMs in Step S11, a step of selecting a migration target guest VM from the selected source host VMs, and a step of selecting a migration destination host VM. The specific method for selecting the migration source host VM, the migration target guest VM, and the migration destination host VM may be the same as that described above with respect to the migration target determination portion 103, and so a description thereof will be omitted here.

### (Effects of First Example Embodiment)

In the first example embodiment, in a case where time-stamped resource data is predicted into the future using a time-series prediction algorithm, it is possible to ensure both calculation speed and accuracy by using Fourier transform and peak detection.

Furthermore, in the first example embodiment, by using high-load VM detection from past data to future predicted results, it is possible to detect timings in a case where a VM is under high load from the past to the future.

### Second Example Embodiment

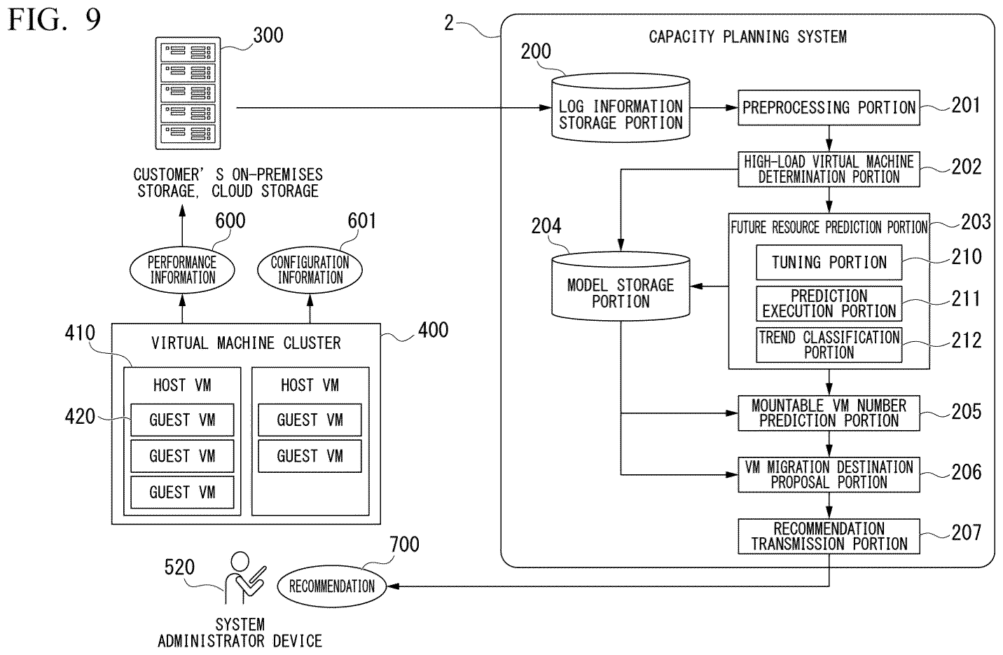

Hereinbelow, a capacity planning system 2 according to the second example embodiment will be described with reference to FIGS. 9 to 22. The capacity planning system 2 may correspond to a more specific example embodiment of the resource optimization device 1. Therefore, additional functions in the capacity planning system 2 can be added to the resource optimization device 1 as appropriate. In the present example embodiment, in order to facilitate understanding, specific numbers are used in the description, but these are merely examples, and predetermined parameters can be set as appropriate.

Further, although the following description will be given using an example in which data is collected and implemented in an on-premise environment, the capacity planning system 2 may also be implemented in the cloud. In a case where implemented this in the cloud, multiple systems are made capable of connecting to the cloud, and the system is realized using data stored in the cloud.

FIG. 9 is a diagram showing a configuration of the capacity planning system 2 according to the present disclosure. The capacity planning system 2 includes a log information storage portion 200, a preprocessing portion 201, a high-load virtual machine determination portion 202, a future resource prediction portion 203, a model storage portion 204, a mountable VM number prediction portion 205, a VM migration destination proposal portion 206, and a recommendation transmission portion 207. The storage 300 receives and stores performance information 600 and configuration information 601 from a virtual machine cluster 400. The performance information 600 may include historical resource data. The configuration information 601 may include data regarding which host VM the guest VM belongs to, and data regarding installed software and middleware. This information is transmitted to the capacity planning system 2 and recorded in the log information storage portion 200. From this information, the capacity planning system 2 can know the dependency relationship between the guest VMs and the host VM, and information about each guest VM and the host VM. The virtual machine cluster 400 includes host VMs 410 and guest VMs 420. The capacity planning system 2 creates a recommendation 700 regarding the migration of the guest VMs 420 between the host VMs 410 and transmits it to the system administrator device 500. The system administrator device 500 can also provide input (e.g., an instruction to select a host VM and/or a guest VM) for a series of processes in the capacity planning system 2 by communicating with the capacity planning system 2.

In the following, the functions and processes performed by each functional unit of the capacity planning system 2 will be described along with a series of operations of the capacity planning system 2. The operations performed by the capacity planning system 2 can be mainly divided into an operation of detecting a high-load VM, an operation of predicting a future VM load state, an operation of predicting the number of mountable VMs, and an operation of proposing a migration destination for a VM. Each of these operations will be explained in turn.

### 1. High-Load VM Detection

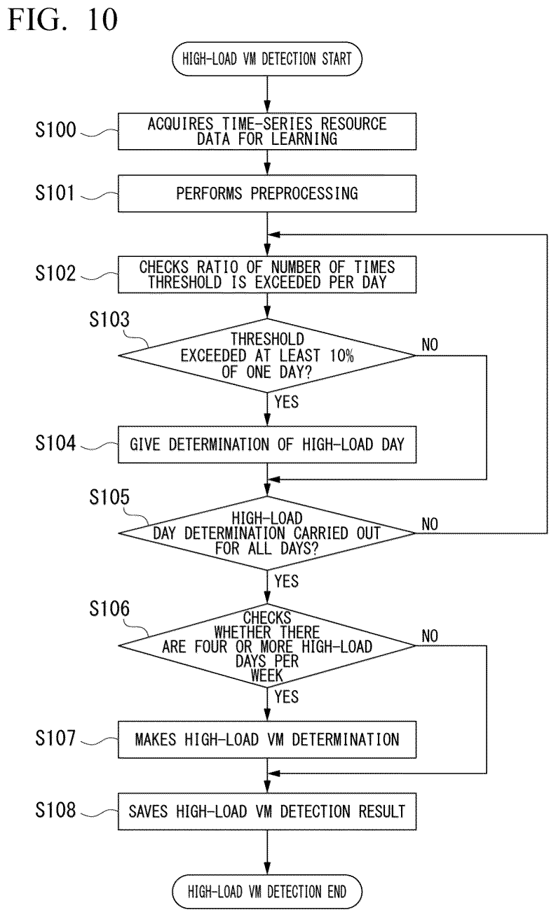

FIG. 10 is a flow diagram of the process of detecting a high-load VM performed by the capacity planning system 2. The high-load VM detection operation is executed by the preprocessing portion 201 and the high-load VM detection portion 202 of the capacity planning system 2. The preprocessing portion 201 acquires the historical resource data from the log information storage portion 200 (step S100). The historical resource data may be time-series resource data with time stamps, such as that illustrated in FIG. 2 in the first example embodiment.

The preprocessing portion 201 performs preprocessing such as complementing missing parts of the acquired historical resource data (step S101). Next, the high-load VM detection portion 202 detects high-load VMs based on the preprocessed historical resource data. The high-load VM detection portion 202 can detect a high-load VM in the same manner as the high-load virtual machine determination portion 102 in the first example embodiment.

Specifically, first, the ratio of the number of times the threshold is exceeded for each first period (the following description will be given taking a case of one day as an example) is obtained (step S102). It is checked whether the time during which the threshold is exceeded exceeds a predetermined percentage of the day (step S103). For example, if the time during which the CPU utilization rate exceeds the threshold of 80% exceeds 10% of a day (that is, if YES in step S103), a flag is set for that day as a high-load period (step S104). In the present example embodiment, an example is described in which the percentage of the first period that exceeds a threshold is obtained to determine whether the first period is a high-load period. However, it may also be determined that the first period is a high-load period based on the percentile and threshold for the first period. Next, the high-load determination is repeated for all the target days (step S105). In a case where the high-load determination is completed for all days (if YES in step S105), the system checks whether, in the second period, which is longer than the first period (in the following, an example of one week will be described), there is a week in which the days determined to be high load number four or more (step S106). If there are four high-load days in a week (YES in step S106), the target host VM is determined to be a high-load host VM (step S107). The results of the high-load determination for each host VM are recorded in the model storage portion 204 as a high-load determination list (step S108). The high-load VM detection portion 202 also performs the above-mentioned high-load VM detection on predicted future resource data, which will be described later, and records the results of this detection in the model storage portion 204 as a high-load determination list. This completes the high-load VM detection operation.

### 2. Future Prediction of VM Load Status

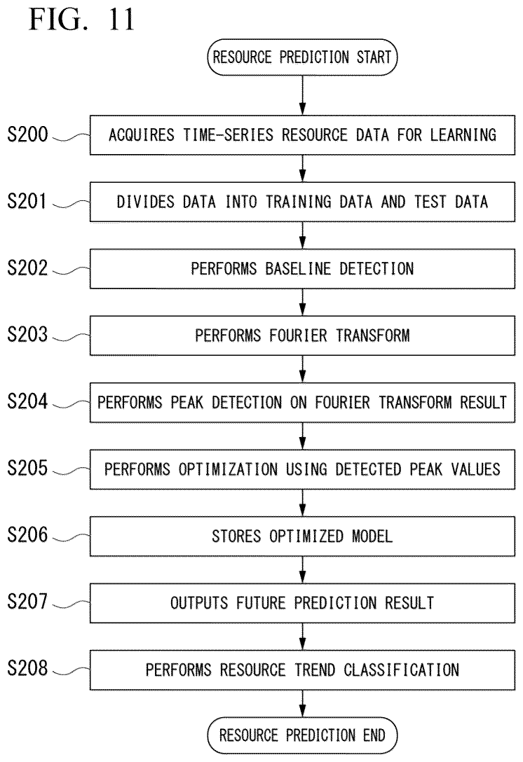

FIG. 11 is a process flow diagram of a future prediction operation of a VM load status (hereinafter, referred to as a resource prediction operation) performed by the capacity planning system 2. The resource prediction operation is executed by the future resource prediction portion 203. The future resource prediction portion 203 is provided with a tuning portion 210, a prediction execution portion 211, and a trend classification portion 212. The future resource prediction portion 203 corresponds to the resource data prediction portion 101 in the first example embodiment, but in addition to the functions of the resource data prediction portion 101 in the first example embodiment, it further includes a trend classification portion 212 that corresponds to the resource trend classification function of the migration target determination portion 103.

In predicting the future load status of a VM, first, the future resource prediction portion 203 acquires historical resource data for learning from the log information storage portion 200 (step S200). Next, the tuning portion 210 divides the data into optimization learning data and verification data (step S201). The tuning portion 210 performs baseline detection and uses data after the baseline change as learning data (step S202). The operation of the baseline detection may be the same as that of the resource data prediction portion 101 described with reference to FIG. 3. The tuning portion 210 performs a Fourier transform on the optimization learning data (step S203). As already described with reference to FIG. 4, peak detection is performed on the result of the Fourier transform (step S204). Using a plurality of detected peak values, the periodic component parameters are optimized (step S205). Details of the optimization are omitted since they are similar to those in the first example embodiment. The optimized machine learning model is stored in the model storage portion 204 (step S206). Next, the prediction execution portion 211 uses the optimized periodic component parameters to input the historical resource data into a machine learning model to perform future prediction and outputs the result (step S207). The trend classification portion 212 performs trend classification on the historical resource data and the prediction results into the 15 trend patterns already shown in FIG. 7 (step S208). This completes the resource prediction operation.

### 3. Prediction of Number of Mountable VMs

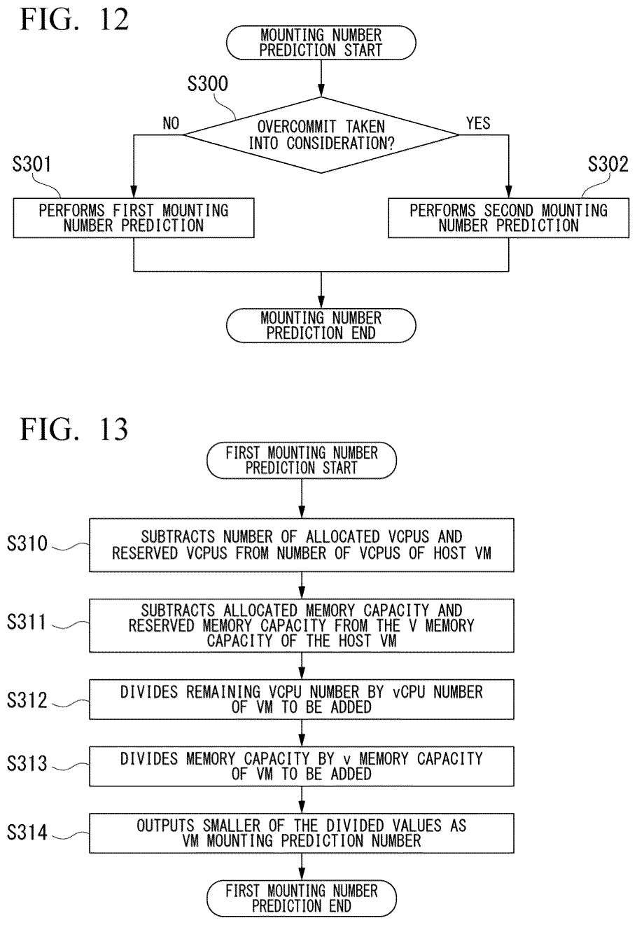

FIG. 12 is a process flow diagram of the operation of predicting the number of mountable VMs, which is performed by the capacity planning system 2. The operation of predicting the number of mountable VMs is executed by the mountable VM number prediction portion 205. In predicting the number of mountable VMs, it is predicted how many additional guest VMs each host VM 310 can mount. First, as shown in FIG. 12, the mountable VM number prediction portion 205 checks whether the target resource takes overcommit into consideration (step S300). If overcommit is not taken into consideration (NO in step S300), a first mounting number prediction is performed (step S301). In a case where overcommit is taken into consideration (YES in step S300), a second mounting number prediction is performed (step S302).

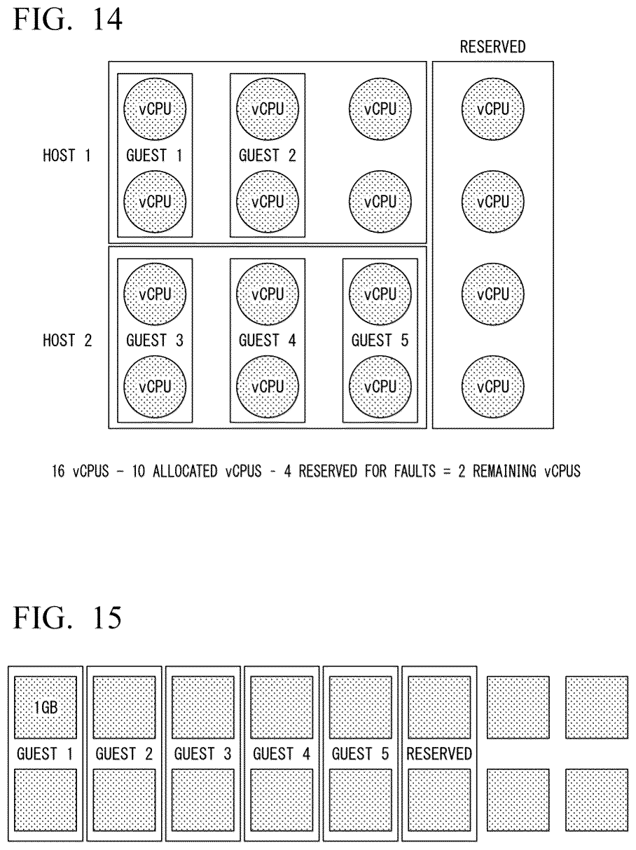

FIG. 13 is a process flow diagram of the first mounting number prediction in a case where overcommit is not taken into consideration. In the first mounting number prediction, first, the number remaining after subtracting the number of allocated vCPUs and reserved vCPUs from the number of vCPUs of the host VM is saved (step S310). In the example of FIG. 14, the number of vCPUs of the host VM is 16, the number of allocated vCPUs is 10, and the number of reserved vCPUs is 4, so the number of remaining vCPUs is 2. Next, the remaining value obtained by subtracting the amount of memory allocated to the guest VM and the amount of reserved memory from the amount of memory installed in the host VM is saved (step S311). In the example of FIG. 15, the onboard memory capacity of the host VM is 16 GB, and the remaining value obtained by subtracting the memory capacity allocated to the guest VM of 10 GB and the reserved memory capacity of 2 GB is 4 GB. Next, the remaining vCPUs are divided by the number of vCPUs allocated to the VM to be added (step S312). The memory capacity calculated in S311 is divided by the memory capacity of the VM to be added (step S313). Then, the smaller of the values calculated in S312 and S313 is output as the VM mounting prediction number (step S314). This completes the operation of predicting the VM mounting number without taking overcommit into consideration.

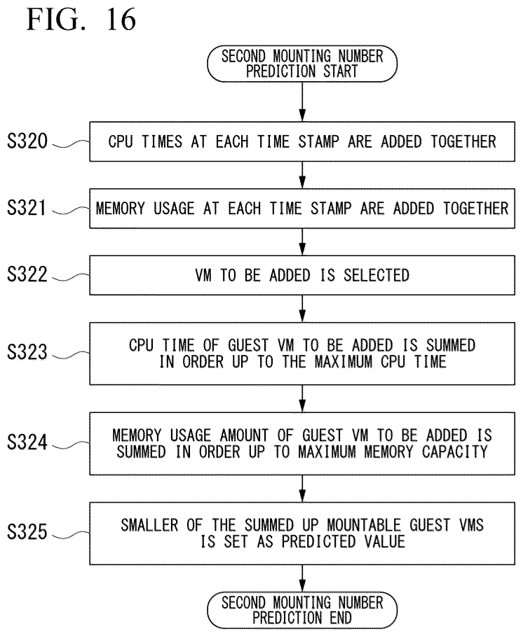

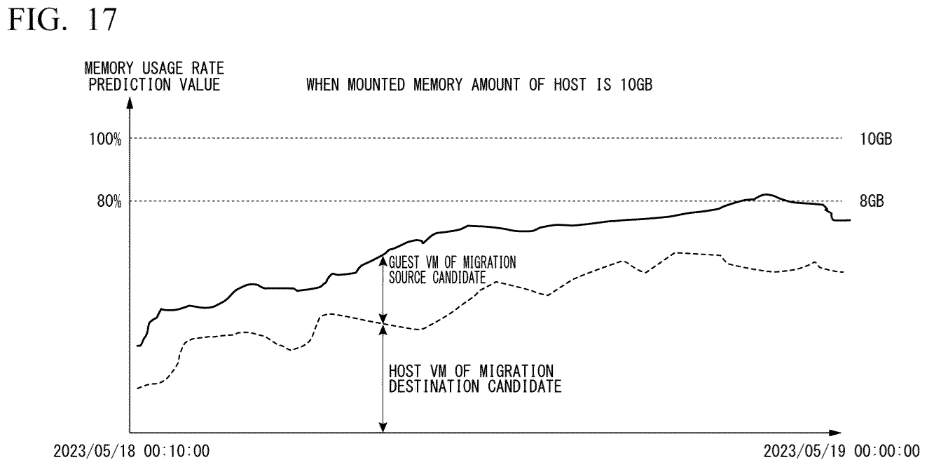

FIG. 16 shows a process flow of the second mounting number prediction executed in a case where overcommit is taken into consideration in S300 (if YES in step S300). In the second mounting number prediction, first, the CPU times of the guests held by the host for each same time stamp are added together (step S320). Similarly, the memory usage of the guests held by the host for each same time stamp is added up (step S321). Next, the guest VM to be added is selected (step S322). This selection may be made by the user or automatically based on a predetermined criterion. Next, the maximum CPU time is obtained from the host's resources, and the CPU time for each timestamp of the guest VM to be added is added in order to the host's CPU time usage up to the maximum CPU time, and the number of guest VMs that can be added is calculated (step S323). In this case, the same guest VM may be used for each guest VM to be added, or different guest VMs may be used in sequence for each guest VM to be added. In a case where the same amount is repeatedly added, the user can more intuitively recognize a host VM with a large amount of free space (the same applies to the amount of memory used, which will be described later). Similarly, the maximum memory capacity of the host is obtained, and the memory usage amount for each timestamp of the guest VM to be added is added in order up to the maximum memory capacity of the host, and how many guest VMs can be added and how many times they can be added is calculated (step S324). As for the guest VMs to be added together, the same one may be used repeatedly, or different ones may be used sequentially, as in the case of the CPU. FIG. 17 shows a graph in which the memory usage for each timestamp of a guest VM to be added is added to the total memory usage of the guests held by the host VM. In the example of FIG. 17, the maximum memory capacity of the host is 10 GB, and there is a possibility to add further guest VMs. Thereafter, the smaller of the numbers of mountable guest VMs calculated in S323 and S324 is used as the predicted number (step S325). This completes the operation of predicting the VM mounting number while taking overcommit into consideration.

### 4. VM Migration Destination Proposal

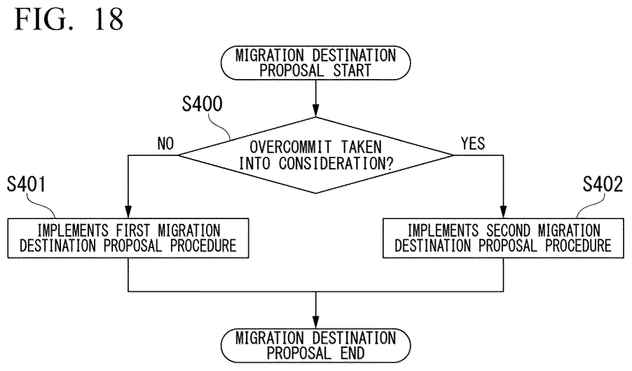

FIG. 18 is a process flow diagram of a VM migration destination proposal operation performed by the capacity planning system 2. The VM migration destination proposal operation is executed by the VM migration destination proposal portion 206.

First, the VM migration destination proposal portion 206 checks whether the target resource takes overcommit into consideration (step S400). If overcommit is not taken into consideration (NO in step S400), the first migration destination proposal procedure is implemented (step S401). If overcommit is taken into consideration in S400 (YES in step S400), a second migration destination proposal procedure is implemented (step S402).

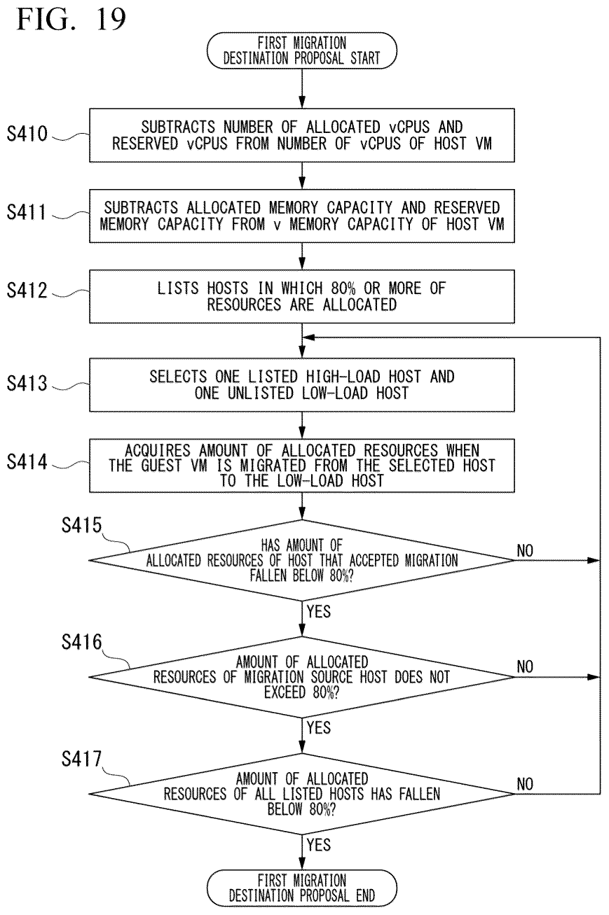

FIG. 19 is a process flow diagram of the first migration destination proposal procedure executed in a case where overcommit is not taken into consideration. The VM migration destination proposal portion 206 first saves the remaining number obtained by subtracting the number of allocated vCPUs and reserved vCPUs from the number of vCPUs of the host VM that is the migration destination candidate (step S410). The migration destination candidate host VM may be selected by a user, may be determined based on a predetermined priority order, or may be determined based on a predicted number of additional mountable VMs. The remaining value obtained by subtracting the amount of memory allocated to the guest VM and the amount of reserved memory from the amount of memory installed in the host VM is saved (step S411). Hosts in which resources are allocated at a threshold rate (for example, 80%) or more are listed as high-load hosts (step S412). Note that the high-load host here may be determined in a manner different from that used in detecting a high-load VM. Next, one high-load host and one unlisted host are selected (step S413). The amount of resources allocated to the high-load host in a case where a guest VM is migrated from the high-load host to a host not on the list is acquired (step S414). It is confirmed whether the amount of allocated resources of the high-load host has fallen below the threshold percentage (step S415). It is confirmed whether the amount of allocated resources does not exceed the threshold percentage in a case where a non-listed host accepts the guest VM (step S416). If there are no problems in the confirmations of step S415 and step S416, a check is made to see if there is another listed host (step S416). In a case where the amount of allocated resources of all hosts falls below the threshold ratio, the first destination proposal procedure is completed (step S417).

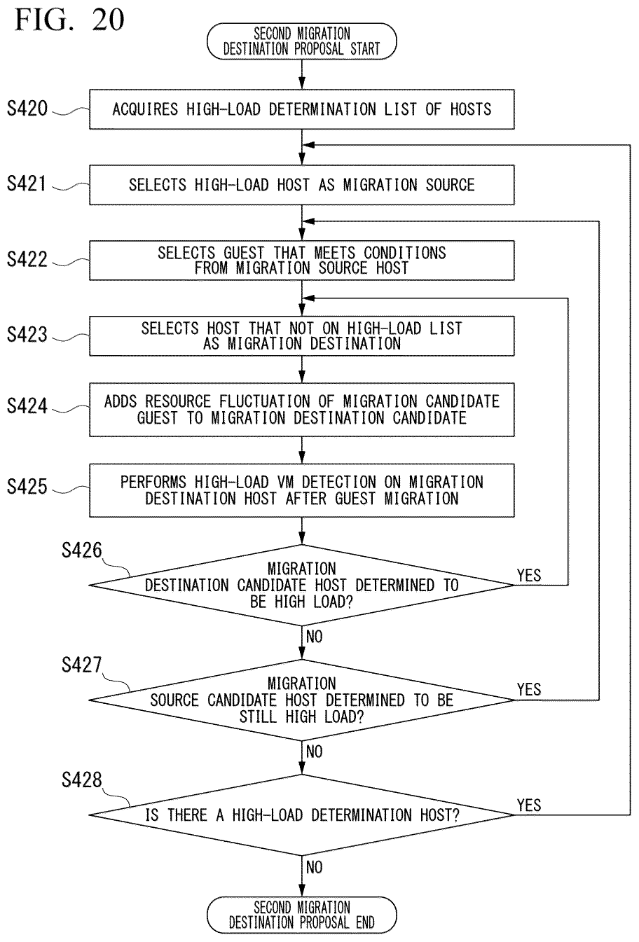

FIG. 20 is a process flow diagram of the second migration destination proposal procedure executed in a case where overcommit is taken into consideration. In the second migration destination proposal procedure, first, the VM migration destination proposal portion 206 acquires a high-load determination list of host VMs from the model storage portion 204 (step S420). A host VM on the high-load determination list is selected as the source host (step S421). From the guest VMs in the selected source host, a guest that meets the conditions described below is selected as a guest VM to be migrated (step S422).

In selecting a migration target guest VM, a guest VM that has a certain trend in the trend classification performed by the trend classification portion 212 of the future resource prediction portion 203 is selected as the first priority. This condition improves the accuracy of the prediction of the resource status after the migration, since the impact on the resource status at the migration destination is constant. Furthermore, in a case where there are a plurality of guest VMs with a certain trend, the VM that is determined to be high-loaded in the high-load VM detection targeting the next guest VM is selected as the second priority. For the rest, the ranking will be in order of highest average resource usage.

Next, after the migration target guest VM is selected, a host that is not included in the high load determination list is selected as a migration destination candidate (step S423). The migration destination candidate host VM may be selected by a user, may be determined based on a predetermined priority order, or may be determined based on a predicted number of additional mountable VMs.

As in the case shown in FIG. 17, the resources of the guest VM to be migrated are added to the resources of the migration destination candidate host for each timestamp (step S424). High-load VM detection is performed on the resources after the addition (step S425). It is confirmed whether the result of the high-load determination is a high load (step S426), and if the migration destination candidate host is a high load, another migration destination candidate host is selected. If not high load, it is checked whether the migration source host is still high-loaded (step S427). If the load is high, another guest is selected as the migration target. If the source host is not high load after the migration, it is checked whether there is another high-load host (step S428). If there are other host VMs, the same process is repeated, and if it is determined that all the host VMs are not under high load, the second migration destination proposal procedure is completed.

As described above, the capacity planning system 2 may determine the migration source host VM, the migration target guest VM, and the migration destination host VM, and the recommendation transmission portion 207 may send this information to the system administrator device 500 as a recommendation 700. Furthermore, the capacity planning system 2 may automatically perform relocation based on the determined source host VM, migration target guest VM, and migration destination host VM.

The capacity planning system 2 according to the second example embodiment differs from the first example embodiment in that it further predicts the number of mountable VMs. Therefore, in a case where it is detected that a host VM is under a high load, the number of guest VMs that can be mounted on each host VM is calculated, and a more optimal arrangement can be determined.

Although the above description assumes an on-premises environment, as described above, this example embodiment can also be implemented in the cloud. In this case, first, with regard to data collection, performance information of the monitored devices, information on installed software, and information on services running on the server may be collected periodically. The information collected periodically is sent via the network to an operations management system in the cloud. The operation management system in the cloud receives the transmitted performance information and event logs.

Regarding the server service classification, the use of the server can be determined from the installed software information and service information. Server uses include DB servers, Web servers, mail servers, file servers, DNS servers, AP servers, backup servers, etc., and category classes for these may be created.

It also allows for capacity planning of resource future projections for each server application. The above-mentioned solution means is implemented from the resource data of the classified server use, and the result is recorded as a category class feature as a trend or feature according to the server use. The recorded features can be used for multi-series modeling (combining predictions) to realize optimal future predictions and capacity planning that take into account the characteristics of server usage. By applying the recorded feature data to an on-premises environment, the same effect can be obtained in an on-premises environment.

### (Effect of Second Example Embodiment)

In the second example embodiment, in addition to the first example embodiment, the number of mountable VMs is predicted. Therefore, in a case where a high load is detected in a host VM, the number of guest VMs that can be mounted on each host VM is calculated, and an optimal placement can be recommended.

### Third Example Embodiment

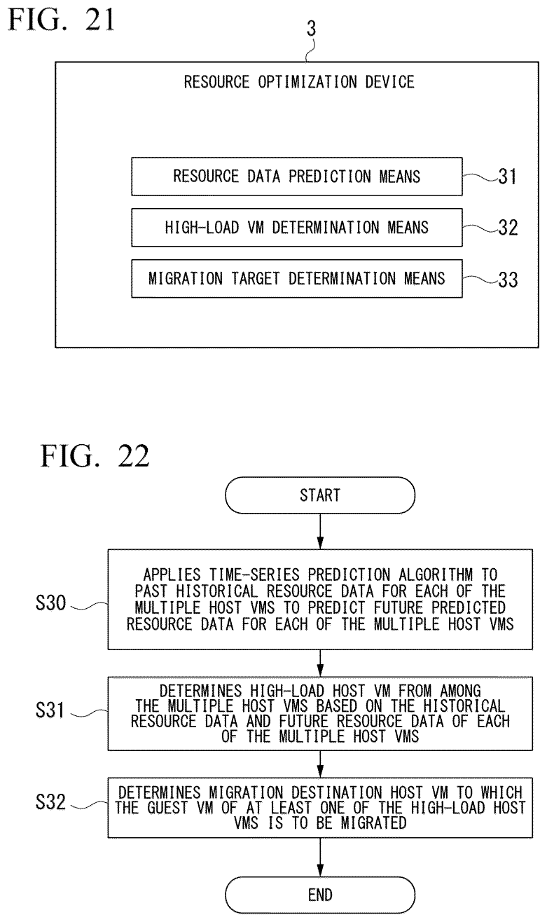

FIG. 21 is a diagram illustrating a resource optimization device 3 according to the present disclosure.

According to this example embodiment, the resource optimization device 3 is provided with at least a resource data prediction means 31 configured to predict future predicted resource data for each of the multiple host virtual machines by applying a time-series prediction algorithm to historical resource data for each of the multiple host virtual machines, a high-load VM determination means 32 configured to determine a high-load host virtual machine from among the multiple host virtual machines based on the historical resource data and future resource data of each of the multiple host virtual machines, and a migration target determination means 33 configured to determine a migration destination host virtual machine to which to move a migration target guest virtual machine in at least one of the high-load host virtual machines. The historical resource data and future predicted resource data are time-series data. Furthermore, the migration destination host virtual machine is a host virtual machine that is not a high-load host virtual machine among the multiple host virtual machines.

Next, the processing of the resource optimization device 3 according to the present disclosure will be described. FIG. 22 is a diagram showing the processing of the resource optimization device 3 according to the present disclosure. The resource data prediction means 31 applies a time-series prediction algorithm to historical resource data for each of the multiple host virtual machines to predict future predicted resource data for each of the multiple host virtual machines (Step S30). The historical resource data and future predicted resource data are time-series data. Next, the high-load VM determination means 32 determines a high-load host virtual machine from among the multiple host virtual machines based on the historical resource data and future resource data of each of the multiple host virtual machines (Step S31). The migration target determination means 33 determines a migration destination host virtual machine to which the migration target guest virtual machine of at least one of the high-load host virtual machines is to be migrated (Step S32). The migration destination host virtual machine is a host virtual machine that is not a high-load host virtual machine among the multiple host virtual machines.

### Fourth Example Embodiment

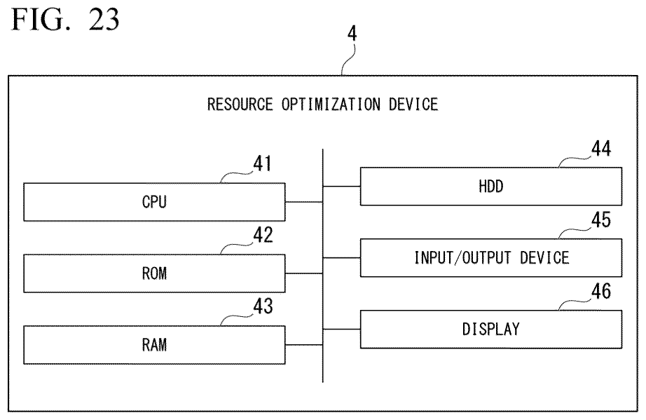

FIG. 23 is a diagram illustrating a hardware configuration of a resource optimization device 4 according to the present disclosure. As shown in this figure, the resource optimization device 4 may be a computer equipped with various hardware components such as a CPU 41, a ROM (Read Only Memory) 42, a RAM (Random Access Memory) 43, a database 44, a communication module 45, a display 46, and the like.

The above configuration enables the client server to recognize the replaced disk array device without changing the configurations of the client server, the original disk array device, and the replacement disk array device.

According to the present disclosure, by determining a high-load host VM based on resource data of the host VMs in the past and future, it is possible to determine a host VM to be migrated more effectively. In addition, it is possible to detect high-load VMs, predict future VM load conditions, and predict the number of mountable VMs, and propose migration destinations for VMs, thereby enabling more efficient resource optimization.

While preferred example embodiments of the disclosure have been described and illustrated above, it should be understood that these are exemplary of the disclosure and are not to be considered as limiting. Additions, omissions, substitutions, and other modifications that would be understood by a person skilled in the art can be made without departing from the scope of the present disclosure. Accordingly, the disclosure is not to be considered as being limited by the foregoing description, and is only limited by the scope of the appended claims.

Some or all of the above-described example embodiments may be described as, but is not limited to, the following supplementary notes.

### (Supplementary Note 1)

A resource optimization device provided with:
a resource data prediction portion configured to apply a time-series prediction algorithm to historical resource data for each of a plurality of host virtual machines to predict future predicted resource data for each of the plurality of host virtual machines, wherein the historical resource data and the future predicted resource data are time-series data;
a high-load virtual machine determination portion configured to determine a high-load host virtual machine among the plurality of host virtual machines based on the historical resource data and the future resource data of each of the plurality of host virtual machines; and a migration target determination portion configured to determine a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

### (Supplementary Note 2)

The resource optimization device according to Supplementary Note 1,
wherein the resource data prediction portion is further configured to
perform a Fourier transform on learning data included in the historical resource data to detect a plurality of peak values; and
apply the time-series prediction algorithm to the historical resource data using a periodicity component parameter corresponding to a peak value of the plurality of peak values.

### (Supplementary Note 3)

The resource optimization device according to Supplementary Note 2,
wherein the resource data prediction portion is further configured to
divide the historical resource data into the learning data and validation data;
apply the time-series prediction algorithm to the learning data using periodic component parameters corresponding to at least two of the detected peak values, and perform a prediction for the same period as the validation data; and
determine a peak value having a higher accuracy as the one peak value based on a comparison between a prediction for the same period as the verification data and the verification data for each of the at least two of the plurality of peak values.

### (Supplementary Note 4)

The resource optimization device according to any one of supplementary notes 1 to 3,
wherein the high-load virtual machine determination portion is further configured to
determine a corresponding first period as being high load in a case where the resource data exceeds a threshold level for a time corresponding to a predetermined percentage of the first period; and
determine the virtual machine to be a high-load virtual machine in a case where the number of the first periods determined to be high load is equal to or greater than a predetermined number within a second period that is longer than the first period.

### (Supplementary Note 5)

The resource optimization device according to any one of supplementary notes 1 to 4, wherein the migration target determination portion is further configured to classify a resource trend for each of the plurality of host virtual machines based on at least one of the historical resource data and the future resource data of each of the plurality of host virtual machines;
the classification is based on a trend classification of a trend component, a seasonal component, and a residual component of the resource data; and
the migration target determination portion is further configured to determine the migration destination host virtual machine based on the classification of the resource trend.

### (Supplementary Note 6)

The resource optimization device according to Supplementary Note 5,
wherein the migration target determination portion is further configured to
preferentially determine a host virtual machine whose trend component is in a constant trend as the migration destination host virtual machine.

### (Supplementary Note 7)

The resource optimization device according to any one of supplementary notes 1 to 6, further provided with a mounted number prediction unit that predicts the number of guest virtual machines that can be additionally mounted by the host virtual machine that is not the high-load host virtual machine from the present to the future; and
the migration target determination portion is further configured to determine the migration destination host virtual machine based at least in part on the number of additional guest virtual machines that can be mounted.

### (Supplementary Note 8)

The resource optimization device according to Supplementary Note 7, wherein the installation quantity prediction unit is further configured to
predict the number of additional guest virtual machines that can be mounted based on whether or not overcommit is taken into account.

### (Supplementary Note 9)

A resource optimization method executed by a computer, including:
a step that applies a time-series prediction algorithm to historical resource data for each of a plurality of host virtual machines to predict future predicted resource data for each of the plurality of host virtual machines, wherein the historical resource data and the future predicted resource data are time-series data;
a step that determines a high-load host virtual machine among the plurality of host virtual machines based on the historical resource data and the future resource data of each of the plurality of host virtual machines; and
a step that determines a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

### (Supplementary Note 10)

The resource optimization method according to Supplementary Note 9, including:
a step that predicts the future predicted resource data;
a step that performs a Fourier transform on learning data included in the historical resource data to detect a plurality of peak values; and
a step that applies the time-series prediction algorithm to the historical resource data using a periodicity component parameter corresponding to a peak value of the plurality of peak values.

### (Supplementary Note 11)

The resource optimization method according to Supplementary Note 10, further including:
a step that predicts the future predicted resource data;
a step that divides the historical resource data into the learning data and validation data;
a step that applies the time-series prediction algorithm to the learning data using periodic component parameters corresponding to at least two of the detected peak values, and performs a prediction for the same period as the validation data; and
a step that determines a peak value having a higher accuracy as the one peak value based on a comparison between a prediction for the same period as the verification data and the verification data for each of the at least two of the plurality of peak values.

### (Supplementary Note 12)

The resource optimization method according to any one of supplementary notes 9 to 11, wherein:
the step of determining the high-load virtual machine determination portion includes
determining a corresponding first period as being high load in a case where the resource data exceeds a threshold level for a time corresponding to a predetermined percentage of the first period; and
determining the virtual machine to be a high-load virtual machine in a case where the number of the first periods determined to be high load is equal to or greater than a predetermined number within a second period that is longer than the first period.

### (Supplementary Note 13)

The resource optimization method according to any one of supplementary notes 9 to 12, wherein:
the step that determines the migration destination host virtual machine further includes:
a step that classifies a resource trend for each of the plurality of host virtual machines based on at least one of the historical resource data and the future resource data for each of the plurality of host virtual machines, the classification being based on trend classification of trend components, seasonal components, and residual components of resource data; and
a step that determines the migration target guest virtual machine based on the resource trend classification.

### (Supplementary Note 14)

The resource optimization method according to any one of supplementary notes 9 to 13, further including a step that predicts the number of guest virtual machines that can be additionally mounted by the host virtual machine that is not the high-load host virtual machine from the present to the future; and
the step that determines the migration destination host virtual machine further includes a step that determines the migration destination host virtual machine based at least in part on the number of additional guest virtual machines that can be mounted.

### (Supplementary Note 15)

The resource optimization method according to Supplementary Note 14, wherein the step of predicting the number of additional guest virtual machines that can be mounted further includes
a step of predicting the number of additional guest virtual machines that can be mounted based on whether or not overcommit is taken into consideration.

### (Supplementary Note 16)

A computer program for causing a processor to function as
a resource data prediction means configured to apply a time-series prediction algorithm to historical resource data for each of a plurality of host virtual machines to predict future predicted resource data for each of the plurality of host virtual machines, wherein the historical resource data and the future predicted resource data are time series data;
a high-load virtual machine determination means configured to determine a high-load host virtual machine among the plurality of host virtual machines based on the historical resource data and the future resource data of each of the plurality of host virtual machines; and
a migration target determination means configured to determine a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

### (Supplementary Note 17)

The computer program according to Supplementary Note 16,
wherein the resource data prediction means is further configured to
perform a Fourier transform on learning data included in the historical resource data to detect a plurality of peak values; and
apply the time-series prediction algorithm to the historical resource data using a periodicity component parameter corresponding to a peak value of the plurality of peak values.

### (Supplementary Note 18)

The computer program according to Supplementary Note 17,
wherein the resource data prediction means is further configured to
divide the historical resource data into the learning data and validation data;
apply the time-series prediction algorithm to the learning data using periodic component parameters corresponding to at least two of the detected peak values, and perform a prediction for the same period as the validation data; and
determine a peak value having a higher accuracy as the one peak value based on a comparison between a prediction for the same period as the verification data and the verification data for each of the at least two of the plurality of peak values.

### (Supplementary Note 19)

The computer program according to any one of supplementary notes 16 to 18,
wherein the high-load virtual machine determination means is further configured to
determine a corresponding first period as being high load in a case where the resource data exceeds a threshold level for a time corresponding to a predetermined percentage of the first period; and
determine the virtual machine to be a high-load virtual machine in a case where the number of the first periods determined to be high load is equal to or greater than a predetermined number within a second period that is longer than the first period.

### (Supplementary Note 20)

The computer program according to any one of supplementary notes 16 to 19, wherein the migration target determination means is further configured to classify a resource trend for each of the plurality of host virtual machines based on at least one of the historical resource data and the future resource data of each of the plurality of host virtual machines;
the classification is based on a trend classification of a trend component, a seasonal component, and a residual component of the resource data; and
the migration target determination means is further configured to determine the migration destination host virtual machine based on the classification of the resource trend.

### (Supplementary Note 21)

The computer program according to Supplementary Note 20,
wherein the migration target determination means is further configured to
preferentially determine a host virtual machine whose trend component is in a constant trend as the migration destination host virtual machine.

### (Supplementary Note 22)

The computer program according to any one of supplementary notes 16 to 21, wherein the computer program further causes the processor to function as a mounted number prediction means that predicts the number of guest virtual machines that can be additionally mounted by the host virtual machine that is not the high-load host virtual machine from the present to a future; and
the migration target determination means is further configured to determine the migration destination host virtual machine based at least in part on the number of additional guest virtual machines that can be mounted.

### (Supplementary Note 23)

The computer program according to Supplementary Note 22, wherein the mounting number prediction means is further configured to predict the number of additional guest virtual machines that can be mounted based on whether or not overcommit is taken into account.

What is claimed is:

1. A resource optimization device comprising:
at least one memory configured to store instructions; and
at least one processor configured to execute the instructions to:
apply a time-series prediction algorithm to historical resource data for each of a plurality of host virtual machines to predict future predicted resource data for each of the plurality of host virtual machines, wherein the historical resource data and the future predicted resource data are time-series data;
determine a high-load host virtual machine among the plurality of host virtual machines based on the historical resource data and the future resource data of each of the plurality of host virtual machines; and
determine a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

2. The resource optimization device according to claim 1, wherein the at least one processor is configured to execute the instructions to:
perform a Fourier transform on learning data included in the historical resource data to detect a plurality of peak values; and
apply the time-series prediction algorithm to the historical resource data using a periodicity component parameter corresponding to a peak value of the plurality of peak values.

3. The resource optimization device according to claim 2, wherein the at least one processor is configured to execute the instructions to:
divide the historical resource data into the learning data and validation data;
apply the time-series prediction algorithm to the learning data using periodic component parameters corresponding to at least two of the detected peak values, and perform a prediction for the same period as the validation data; and
determine a peak value having a higher accuracy as the one peak value based on a comparison between a prediction for the same period as the verification data and the verification data for each of the at least two of the plurality of peak values.

4. The resource optimization device according to claim 1, wherein the at least one processor is configured to execute the instructions to:
determine a corresponding first period as being high load in a case where the resource data exceeds a threshold level for a time corresponding to a predetermined percentage of the first period; and
determine the virtual machine to be a high-load virtual machine in a case where a number of the first periods determined to be high load is equal to or greater than a predetermined number within a second period that is longer than the first period.

5. The resource optimization device according to claim 1, wherein the at least one processor is configured to execute the instructions to: classify a resource trend for each of the plurality of host virtual machines based on at least one of the historical resource data and the future resource data of each of the plurality of host virtual machines; and
determine the migration target guest virtual machine based on the resource trend classification,
wherein the classification is based on a trend classification of a trend component, a seasonal component, and a residual component of the resource data.

6. The resource optimization device according to claim 5, wherein the at least one processor is configured to execute the instructions to
preferentially determine a guest virtual machine in which the trend component has a constant trend as the migration target guest virtual machine.

7. The resource optimization device according to claim 1, wherein the at least one processor is configured to execute the instructions to:
predict a number of guest virtual machines that can be additionally mounted by the host virtual machine that is not the high-load host virtual machine from the present to the future; and
determine the migration destination host virtual machine based at least in part on the number of additional guest virtual machines that can be mounted.

8. The resource optimization device according to claim 7, wherein the at least one processor is configured to execute the instructions to predict the number of additional guest virtual machines that can be mounted based on whether or not overcommit is taken into account.

9. A resource optimization method executed by a computer, the method comprising:
applying a time-series prediction algorithm to historical resource data for each of a plurality of host virtual machines to predict future predicted resource data for each of the plurality of host virtual machines, wherein the historical resource data and the future predicted resource data are time-series data;
determining a high-load host virtual machine among the plurality of host virtual machines based on the historical resource data and the future resource data of each of the plurality of host virtual machines; and
determining a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.

10. The resource optimization method according to claim 9 further comprising:
performing a Fourier transform on learning data included in the historical resource data to detect a plurality of peak values; and
applying the time-series forecasting algorithm to the historical resource data using a periodicity component parameter corresponding to a peak value of the plurality of peak values.

11. The resource optimization method according to claim 10 further comprising:
dividing the historical resource data into the learning data and validation data;
applying the time-series prediction algorithm to the learning data using periodic component parameters corresponding to at least two of the detected peak values, and performing a prediction for the same period as the validation data; and
determining a peak value having a higher accuracy as the one peak value based on a comparison between a prediction for the same period as the verification data and the verification data for each of the at least two of the plurality of peak values.

12. The resource optimization method according to claim 9 further comprising:
determining a corresponding first period as being high load in a case where the resource data exceeds a threshold level for a time corresponding to a predetermined percentage of the first period; and
determining the virtual machine to be a high-load virtual machine in a case where the number of the first periods determined to be high load is equal to or greater than a predetermined number within a second period that is longer than the first period.

13. The resource optimization method according to claim 9 further comprising:
classifying a resource trend for each of the plurality of host virtual machines based on at least one of the historical resource data and the future resource data of each of the plurality of host virtual machines; and
determining the migration target guest virtual machine based on the resource trend classification,
wherein the classification being based on trend classification of trend components, seasonal components, and residual components of the resource data.

14. The resource optimization method according to claim 13 further comprising:
preferentially determining a guest virtual machine in which the trend component has a constant trend as the migration target guest virtual machine.

15. The resource optimization method according to claim 9 further comprising:
predicting the number of guest virtual machines that can be additionally mounted by the host virtual machine that is not the high-load host virtual machine from the present to the future; and
determining the migration destination host virtual machine based at least in part on the number of additional guest virtual machines that can be mounted.

16. The resource optimization method according to claim 15 further comprising:
predicting the number of additional guest virtual machines that can be mounted based on whether or not overcommit is taken into account.

17. A non-transitory storage medium storing a computer program for causing a processor to execute:
applying a time-series prediction algorithm to historical resource data for each of a plurality of host virtual machines to predict future predicted resource data for each of the plurality of host virtual machines, wherein the historical resource data and the future predicted resource data are time series data;
determining a high-load host virtual machine among the plurality of host virtual machines based on the historical resource data and the future resource data of each of the plurality of host virtual machines; and
determining a migration destination host virtual machine to which a migration target guest virtual machine of at least one of the high-load host virtual machines is to be moved, the migration destination host virtual machine being a host virtual machine that is not the high-load host virtual machine among the plurality of host virtual machines.
